(19) United States
(12) Patent Application Publication
(10) Pub. No.: US 2026/0014748 A1
(43) Pub. Date: Jan. 15, 2026

(54) EXTRUDED BOARD WITH REALISTIC APPEARANCE

(71) Applicant: Poly-Wood, LLC, Syracuse, IN (US)

(72) Inventors: Sean Douglas Rassi, Syracuse, IN (US); Chad Alan Rassi, Milford, IN (US); Curtis Blake Grady, Syracuse, IN (US)

(21) Appl. No.: 18/770,957

(22) Filed: Jul. 12, 2024

(51) Int. Cl. B29C 48/17; B29C 48/00; B29C 48/07; B29C 48/30; B29K 23/00; B29K 105/04; B29L 7/00

(52) U.S. Cl. CPC B29C 48/175; B29C 48/0012; B29C 48/07; B29C 48/304; B29K 2023/065; B29K 2105/04; B29K 2995/0021; B29L 2007/001; B29L 2007/002

(57) ABSTRACT

In one embodiment, an extruded board includes an extruded core having an outer circumference, the outer circumference including a first side and a second side opposite to the first side, the core including foamed high density polyethylene (HDPE). A cap layer is co-extruded on the first side, the cap layer including at least one co-extruded streak portion at an outer surface of the cap layer, the at least one co-extruded streak portion including HDPE which is colored differently from an adjacent co-extruded HDPE portion of the outer surface.

### FIELD

This disclosure relates to extruded plastic articles.

### BACKGROUND

Wood is a common and highly valued resource in the manufacture of items including outdoor furniture. Wood is a natural material which is strong and typically quite durable. Nonetheless, wood is a natural product which is susceptible to various pests and decay. Accordingly, wood can deteriorate over time.

A historical benefit of wood is that wood is a renewable resource. As the demand for wood has increased, however, the sourcing of wood has become problematic. Wood boards which are used in the manufacture of items also have a variety of grain patterns which add tremendously to the beauty of the finished products. Different varieties of wood, however, produce different grain patterns, with some of the more desirable grain patterns being found in wood types which are not as readily renewable as other types of wood.

In response to the difficulty in overcoming some of the above-described problems, various attempts have been made to replicate the look of wood in non-wood products. In some of these approaches, wood is mixed with a resin in order to extrude an artificial board. A major shortcoming of these approaches is that the resulting product looks more like a plastic board than a wood board.

Other approaches to mimicking the look of real wood is the embossing of boards with a grain-like pattern. While this approach provides, at least to some extent, a grain-like feel to the boards and a superficial three-dimensional look to the grain, simply embossing a board fails to achieve a true three-dimensional look of wood grain which provides the basic beauty of wood boards.

Some processes have been developed in an attempt to more closely mimic the three-dimensional look of wood grain. For example, U.S. Pat. No. 8,955,281, published on Feb. 17, 2015 describes a process wherein colored streakers are introduced into a transparent or translucent matrix. The streakers are selected to melt during processing of the extrudate such that they are not fully mixed with the rest of the extrudate. The result is a “streak” within the transparent or translucent material which provides a depth to the product. Additional “wood-like” characteristics are provided by embossing a grain-like texture into the transparent or translucent. The streaks in these products help provide a three-dimensional look of wood grain when viewed from afar. Of course, graining of natural wood is not simply the result of streaks of color in a transparent or translucent matrix.

What is needed therefore is a board which presents a realistic look similar to the look of natural wood. A further need exists for realistic board which can be manufactured without excessive modification of known devices.

### SUMMARY

In one embodiment, an extruded board includes an extruded core having an outer circumference, the outer circumference including a first side and a second side opposite to the first side, the core including foamed high density polyethylene (HDPE). A cap layer is co-extruded on the first side, the cap layer including at least one co-extruded streak portion at an outer surface of the cap layer. The at least one co-extruded streak portion includes HDPE which is colored differently from an adjacent co-extruded HDPE portion of the outer surface.

In one or more embodiments, the outer surface is embossed.

In one or more embodiments the at least one co-extruded streak portion comprises a plurality of co-extruded streak portions. Each of the plurality of co-extruded streak portions is non-determinatively distributed in the cap layer.

In one or more embodiments the cap layer extends completely around the outer circumference of the extruded core.

In one or more embodiments the extruded core is colored using a first color concentrate. The cap layer is colored using a second color concentrate. The first and second color concentrate have the same color. The plurality of co-extruded streak portions are colored using a streaker having a color different from the color of the first and second color concentrate.

In one or more embodiments each of the plurality of co-extruded streak portions exhibit uneven thickness, uneven width, and/or uneven length.

In one or more embodiments the plurality of co-extruded streak portions includes a first streak portion having a first color formed using a streaker having a first color, and a second streak portion having a second color formed using a streaker having a second color. The first and second colors are different colors.

In accordance with one embodiment, the extruded board is formed by melting a first high density polyethylene (HDPE) resin and then foaming the melted first HDPE resin. The foamed first HDPE is then extruded through a first die using a first extruder to form the extruded core. A second (HDPE) resin is also melted. A plurality of first color streakers is provided in the melted second HDPE resin. The plurality of first color streakers is elongated in the melted second HDPE resin to form at least one streaked HDPE portion of melted second HDPE resin, the at least one streaked HDPE portion including HDPE which is colored differently from an adjacent portion of the melted second HDPE resin. The cap layer is then formed by co-extruding the at least one streaked HDPE portion and the adjacent portion of the melted second HDPE resin onto the first side of the extruded core using a second extruder. The co-extruded at least one streaked HDPE portion forms the at least one co-extruded streak portion at the outer surface of the cap layer.

In one or more embodiments of forming the extruded board, the outer surface of the cap layer is embossed.

In one or more embodiments of forming the extruded board the at least one co-extruded streak portion comprises a plurality of co-extruded streak portions and each of the plurality of co-extruded streak portions is non-determinatively distributed in the cap layer.

In one or more embodiments of forming the extruded board forming the cap layer further includes forming the cap layer completely around a circumference of the core.

In one or more embodiments of forming the extruded board the foamed first HDPE resin is colored using a first color concentrate, the melted second HDPE resin is colored using a second color concentrate, and the first color concentrate and the second color concentrate have the same color. Additionally, the streakers have a color different from the color of the first color concentrate and the second color concentrate.

In one or more embodiments of forming the extruded board the foamed first HDPE resin is colored using a first color concentrate, the melted second HDPE resin is colored using a second color concentrate, and the first color concentrate and the second color concentrate have the same color. Additionally, the streakers include a first plurality of streakers having a first color and a second plurality of streakers having a second color. The first color is different from the second color and the color of the first color concentrate and the second color concentrate is different from the first color and the second color.

In one or more embodiments of forming the extruded board forming the cap layer includes providing a co-extruder die. The co-extruder die includes a cap layer extruder channel aligned with the first die and configured to receive the core. The cap layer extruder channel has a height and a width greater than a height and a width of the core. The co-extruder core further includes an inlet operably connected to the second extruder, a first flow channel extending from the inlet to a location above the cap layer extruder channel and opening to an upper co-extrusion chamber portion, and a second flow channel extending from the inlet to a location below the cap layer extruder channel and opening to a lower co-extrusion chamber portion. The upper co-extrusion chamber portion and the lower co-extrusion chamber portion form a co-extrusion chamber positioned between the first die and the cap layer extruder channel. The co-extrusion chamber is configured to receive the core from the first die. The co-extrusion chamber has a height and a width greater than the height and the width of the cap layer extruder channel. The method includes contacting the core with the at least one streaked HDPE portion and the adjacent portion of the melted second HDPE resin completely around a circumference of the core in the co-extrusion chamber.

### BRIEF DESCRIPTION OF THE DRAWINGS

FIG. 1 depicts a portion of a photograph of a perspective view of a cut co-extruded board in accordance with the disclosure;

FIG. 2 depicts an enlarged portion of the portion of the photograph of FIG. 1;

FIG. 3 depicts a photograph of a top view of the cut co-extruded board of FIG. 1;

FIG. 4 depicts a partial end view of a co-extrusion system including two extruders used to form the co-extruded board of FIG. 1;

FIG. 5 is a partial cross-sectional view of the co-extrusion system of FIG. 4 taken along the line A-A of FIG. 4;

FIG. 6 depicts a perspective view of the core compression die of the co-extrusion system of FIG. 4;

FIG. 7 depicts a plan view of the inlet of the core compression die of the co-extrusion system of FIG. 4;

FIG. 8 depicts a plan view of the outlet of the core compression die of the co-extrusion system of FIG. 4;

FIG. 9 depicts a plan view of the outlet of the capping die of the co-extrusion system of FIG. 4;

FIG. 10 depicts a plan view of the inlet of the capping die of the co-extrusion system of FIG. 4;

FIG. 11 depicts a perspective view of the capping die of the co-extrusion system of FIG. 4;

FIG. 12 depicts a side view of the capping die of the co-extrusion system of FIG. 4;

FIG. 13 depicts a simplified schematic of a control system for the co-extrusion system of FIG. 4; and

FIG. 14 depicts a method of producing the co-extruded board of FIG. 1 using the co-extrusion system of FIG. 4.

### DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles of the disclosure as would normally occur to one skilled in the art to which this disclosure pertains.

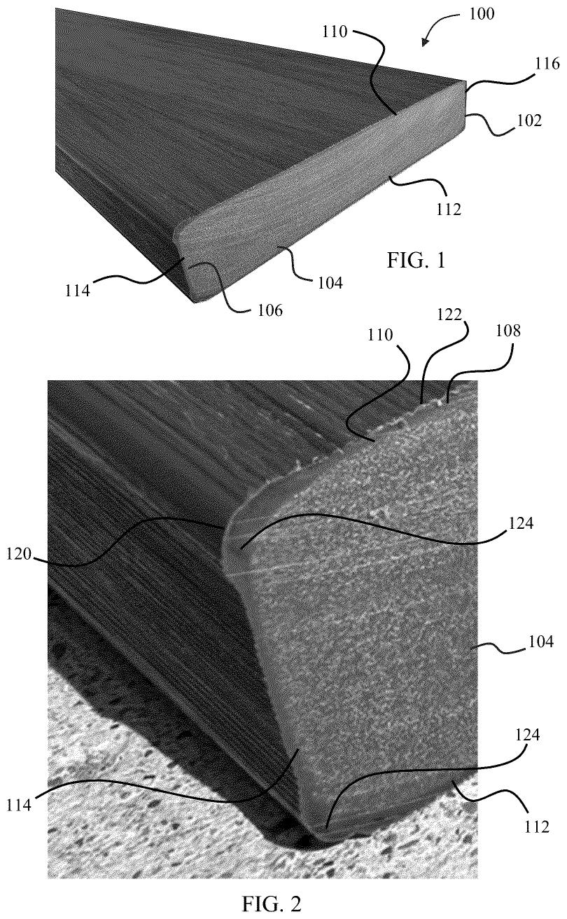

Referring now to FIG. 1, there is shown a portion of a photograph of a co-extruded board 100. The board 100 includes a sawed end 102 which reveals a core portion 104 and a cap layer 106. The core portion 104, a portion of which is shown in FIG. 2, includes an outer surface 108 which includes upper side 110 and lower side 112 which is opposite the upper side 110. The upper and lower sides 110/112 are joined by connecting sides 114/116. The sides 110/112/114/116 together define an outer circumference of the core 104. The core 104 is extruded foamed high density polyethylene (HDPE). In some embodiments, the foamed HDPE is colored using a colorant.

The cap layer 106 is a co-extruded layer including an outer surface 120 and extends, in this embodiment, completely about the outer circumference of the core 104. The cap layer 106 is formed using HDPE which is co-extruded onto the core 104 as discussed in more detail below. In some embodiments the cap layer HDPE is colored using a colorant which in some embodiments is the same color as the colorant used in the foamed HDPE of the core 104. In some embodiments, the colorants in the core 104 and the cap layer 106 are different colors.

The cap layer 106 includes an embossed pattern 122 which in this embodiment is applied to all four sides of the outer surface 120 of the cap layer 106. In some embodiments less than all four of the sides are embossed. The embossed pattern 122 is visible in FIGS. 1 and 2 as a pattern of “bumps” or “indentations” in the outer surface 120. Also shown in FIG. 2 are streaks 124 which are present in the cap layer 106, but not in the core 104.

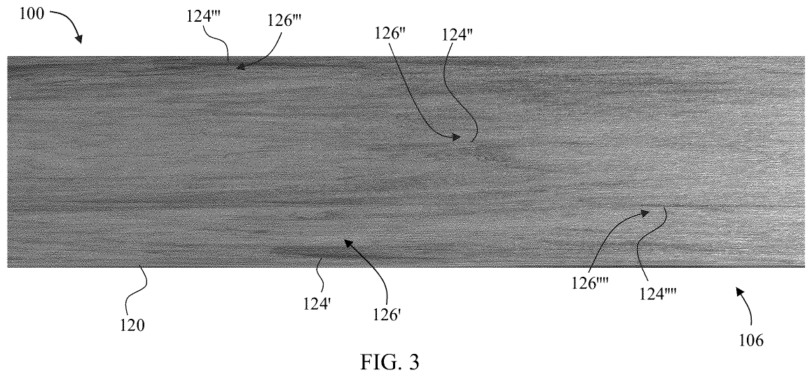

At least some of the streaks 124 extend to the outer surface 120 of the cap layer 106 as shown more clearly in FIG. 3. A number of streaks 124 are visible in the outer surface 120 of the cap layer 106 including streak 124′, streak 124″, streak 124″ and streak 124″. Each of the streaks 124′, 124″, 124″ and 124″ is shaped differently from each of the other streaks 124′, 124″, 124′″ and 124′″. Thus, while the streak 124′″ is somewhat linear, the streak 124″ is more of a chevron shape. The streaks 124 in the board, including the streaks 124′, 124″, 124′″ and 124″, thus present as linear streaks, cathedrals, arches, chevrons, and other shapes.

Streaks of different types have an overall width across the width of the board 100 (top to bottom in FIG. 3) which are different from the overall width of the other streaks. For example, the streak 124′″ is relatively narrow while the streak 124′ has larger overall width. Likewise, the axial coverage of the streaks 124′, 124″, 124″ and 124″ vary along the length of the board 100. For example, the terminus of the streak 106 is farther to the left than the terminus of the streak 110.

Even streaks which are somewhat similar are typically different from each other. For example, streaks 124′ and 124″ are both generally linear. The streak 124″, however, is narrower and not as dark as the streak 124″. Additionally, each of the streaks 124 is non-uniform. The common aspect of the streaks 124 is that each streak 124 is colored differently with respect to an immediately adjacent portion 126 of the cap layer 106, which in some instances is a portion of another streak 124. The different coloration of the HDPE within the cap layer 106 is a function of the non-determinative distribution of streakers present in the HDPE used to form the cap layer 106 as discussed in more detail below. Thus, while in some embodiments the embossed pattern 122 is a repeating pattern, because the streaks 124 are non-determinatively distributed in the cap layer 106 the overall appearance of the cap layer 106 is a non-repeating pattern.

The end result is that the board 100 exhibits a three-dimensional character which is constantly shifting over the length and width of the board. The board 100 is thus aesthetically pleasing, exhibiting a “natural” look like the look of grains in wood boards.

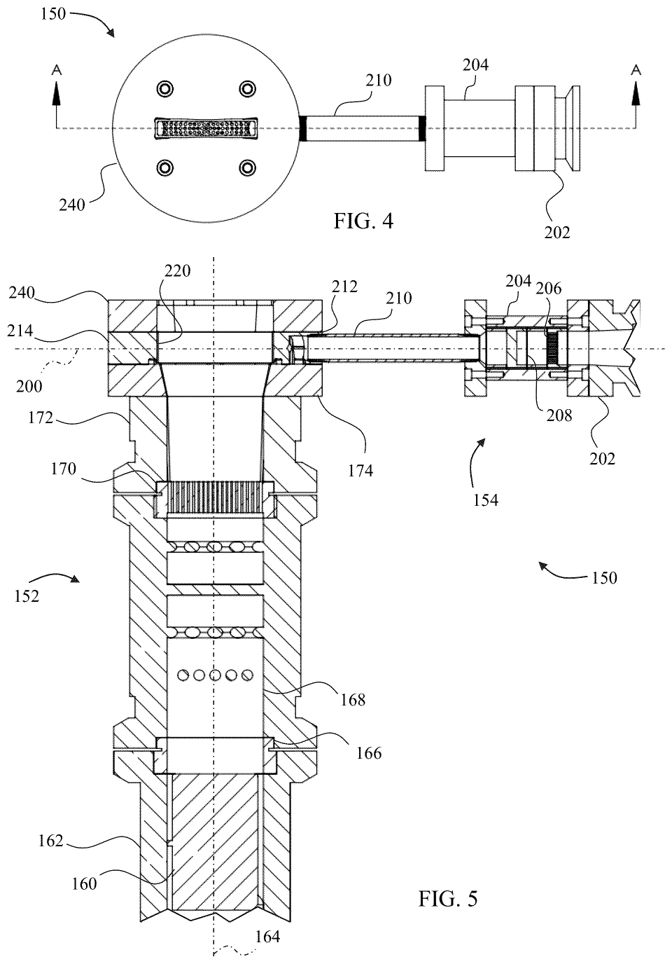

The board 100 is formed using a co-extrusion system 150 partially depicted in FIGS. 4 and 5 in simplified form. The co-extrusion system 150 includes a core extruder 152, and a cap layer extruder 154. The extruders 152/154 in one embodiment are both single stage extruders.

The core extruder 152 includes a screw 160 which extends within a barrel 162 and defines a first extruder axis 164. A clamp 166 joins the barrel 162 to a core static mixer 168. A breaker plate 170 is positioned at the outlet of the core static mixer 168. A core extruder adapter 172 connects the outlet of the breaker plate 170 to a core compression die 174.

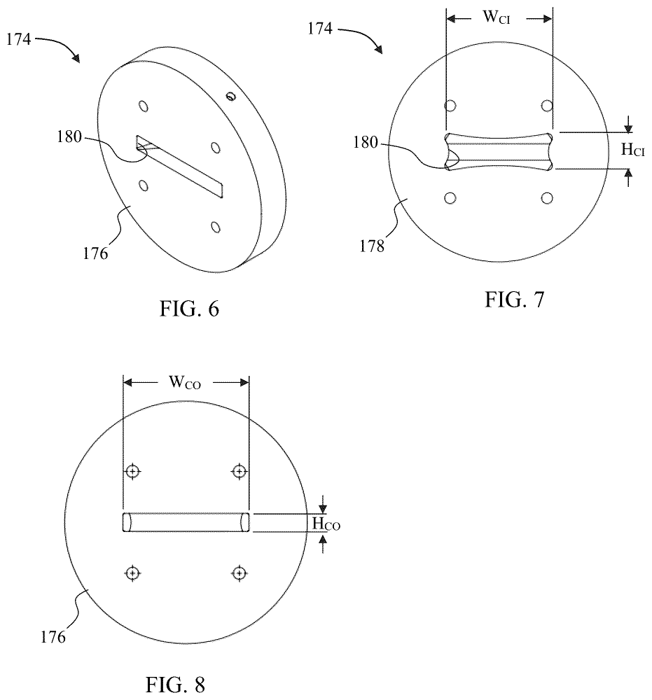

The core compression die 174 includes an outlet face 176 shown in FIG. 6 and an inlet face 178 shown in FIG. 7. A core extruder channel 180 extends through the core compression die 174. As shown in FIG. 8, the core extruder channel 180 at the outlet of the core compression die 174 has a width W_{CO} and a height H_{CO}. The core extruder channel 180 at the inlet of the core compression die 174, which is in the form of a “dog bone” as seen best in FIG. 7, has a width W_{CO} and a height H_{CI}.

Returning to FIGS. 4 and 5, the cap layer extruder 154 likewise includes a screw and barrel (not shown) which define a cap layer extruder axis 200 and which are connected by a cap layer extruder adapter 202 to a static mixer tube 204 that includes two static mixers 206 and 208. The outlet of the static mixer tube 204 is connected by a connecting pipe 210 to an inlet 212 of a co-extruder or capping die 214.

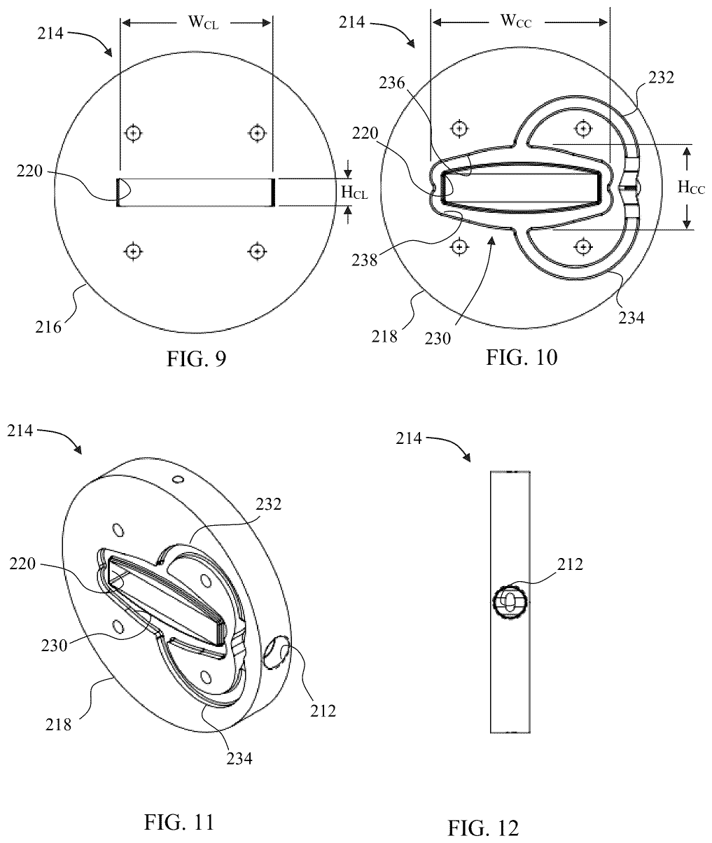

The capping die 214 includes an outlet face 216 shown in FIG. 9 and an inlet face 218 shown in FIG. 10. A cap layer extruder channel 220 extends through the capping die 214. As shown in FIG. 9, the cap layer extruder channel 220 at the outlet of the capping die 214 has a width W_{CL} and a height H_{CL}.

As shown in FIGS. 10 and 11, the inlet face 218 opens to a co-extrusion chamber 230. The co-extrusion chamber 230 has a width W_{CC} and a height H_{CC}. The co-extrusion chamber 230 is connected to the inlet 212, also shown in FIG. 12, by an upper flow channel 232 which flows into an upper co-extrusion chamber portion 236 and a lower flow channel 234 which flows into a lower co-extrusion chamber portion 238. The co-extrusion chamber 230, the upper flow channel 232, and the lower flow channel 234 are each defined by the capping die 214 and the outlet face 176 of the core compression die 174. The co-extrusion chamber 230 is thus located between the outlet face 176 and the cap layer extruder channel 220. The cap layer extruder channel 220 feeds an exit die 240 (FIG. 5).

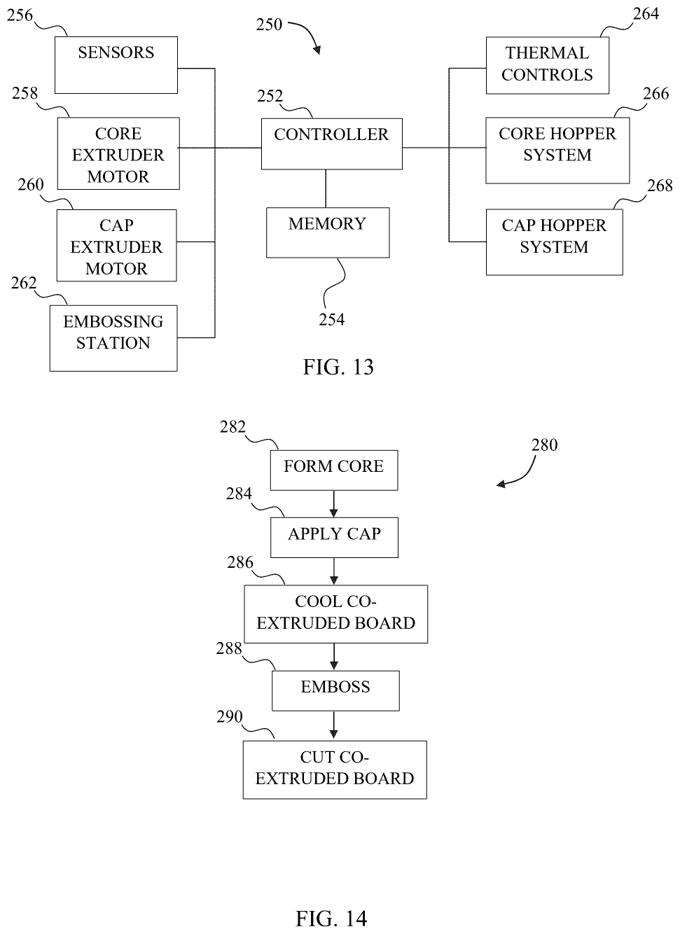

The co-extrusion system 150 is controlled by a control system 250 shown in simplified schematic form in FIG. 13. The control system 250 includes a controller 252 which is operably connected to a memory 254. Stored within the memory 254 are program instructions. The program instructions are executed by the controller 252 to perform the processes described herein. In some embodiments, the controller 252 and memory 254 are embodied as a plurality of controllers and/or memories.

The controller 252 is operably connected to a variety of sensors 256. The sensors 256 include one or more of temperature sensors, pressure sensors, rotation sensors, weight sensors, etc. which provide data used by the controller 252 to control the co-extrusion system 150. The controller 252 is further operably connected to a core extruder motor 258 which drives the screw 160, cap extruder motor 260 which controls the screw for the cap extruder 154, an embossing station 262, thermal controls 264, a core hopper system 266, and a cap hopper system 268.

Further details of the co-extrusion system 150 are provided in the following description of an exemplary process for forming the co-extruded board 100 of FIG. 1. As shown in FIG. 14, the process 280 begins with forming the core 104. To this end, the controller 252 controls provision of a blend of raw materials to the core extruder 152 from the core hopper system 266. The blend in various embodiments includes a base resin which includes high density polyethylene (HDPE), chemical foaming agents (CFA's) and/or nucleators, and in some embodiments color concentrates (base color). The base color is selected in some embodiments so as to complement a base color of the cap layer 106 and/or streak colors so as to “hide” damage to the cap layer when the board is in use. The base color additive may include UV stabilizers. In one embodiment, nucleator is provided at about 0.4% by weight of the blend of raw materials. The controller 252 further controls the core extruder motor 258 to move the blended raw materials through the barrel 162 while further controlling the thermal controls 264 to melt the base resin. To this end, the thermal controls include a number of thermocouples extending into the barrel 162. The screw 160 and core static mixer 168 are configured to provide a thorough mixing of the melted extrudate. Nitrogen gas is then injected into the extrudate prior to entry of the extrudate into the core static mixer 168. Accordingly, foaming of the core extrudate commences.

As noted above, the core extruder channel 180 at the inlet of the core compression die 174 is a traditional “dog bone” in shape. The height of the core extruder channel 180 at the inlet (Hcr) is greater than the height of the core extruder channel 180 at the outlet (H_{CO}) while the width of the core extruder channel 180 at the inlet (WCI) is less than the width of the core extruder channel 180 at the outlet (W_{CO}). The net effect is that the partially foamed HDPE is compressed into a rectangular form as it exits the core compression die 174 and enters the co-extrusion chamber 230.

As the core 104 is being formed, at block 284 the controller 252 controls provision of a blend of raw materials to the cap extruder 154 from the cap hopper system 268. The blend in various embodiments includes a base resin which includes high density polyethylene (HDPE), and in some embodiments color concentrates (base color). As noted above, the base color is selected in some embodiments so as to complement the base color of the core 104.

The blend of raw materials to the cap extruder 154 further includes streakers. The particular streakers used in a given application are largely a design choice. Nonetheless, several principles are typically followed. For example, in order for the process described in further detail below to produce “grain” patterns, the streakers are selected to include a material which melts at a temperature and pressure different from the materials selected for the base cap resin and base cap color of the cap layer 106. Typically, the bulk material of the streaker bead or pellet will have a higher melting point. In some embodiments, only the outer shell of the pellet has a higher melting point.

Another consideration for the streaker material is the opacity of the streaker material. Generally, the streakers will exhibit a higher opacity than the base color concentrate. Additionally, while in some embodiments a streaker of a single color is used, in other embodiments two or more streaker colors are used. Even when a single streaker color is used, the resulting grain pattern will typically exhibit multiple colors because of the interaction of the streakers with the base color and the resin as discussed in more detail below.

The streakers are provided at about 0.2% by weight of the blend of raw materials for the cap layer. For applications wherein a “tighter” or darker grain pattern is desired, a slightly larger amount of streakers may be provided. Conversely, a “looser” or lighter grain pattern with less streaks can use a lesser amount. Additional variation in the grain pattern is achieved by modifications to the size and shape of the streakers.

The controller 252 further controls the cap extruder motor 260 to move the blended raw materials through the barrel of the cap extruder 154 while further controlling the thermal controls 264 to melt the base resin for the cap layer 106. To this end, the thermal controls 264 include a number of thermocouples extending into the barrel of the cap extruder 154.

The cap extruder screw and cap static mixers 206 and 208 are configured to provide a thorough mixing of the melted extrudate without fully melting the streakers. Nonetheless, some of the streakers melt or partially melt. Some of the melted streakers are therefore mixed by the static mixers 206/208 into the colored base cap layer resin, creating deeper hues of the base cap layer resin. This adds to the complexity of the board. Streakers which are melted toward the end of the static mixer 208, however, are not mixed or at least not thoroughly mixed. Thus, these streakers create portions of colored HDPE which present as areas of elongated colored HDPE of varying widths, depths, and lengths.

As the cap layer extrudate approaches the connecting pipe 210, the cap layer extrudate is substantially completely mixed other than the streaking discussed above and further mixing is not needed. Consequently, there are no significant shear forces provided in the connecting pipe 210. Accordingly, the potential for additional melting of streaker pellets is substantially reduced, even as pressure is increased to force the cap layer extrudate into the capping die 214. This allows for increased temperatures within the connecting pipe 210. Accordingly, the temperature of the cap layer extrudate in one embodiment is increased to about 340 degrees Fahrenheit in the connecting pipe 210.

The cap layer extrudate, with streaked HDPE, is then forced through the inlet 212 of the capping die 214 where a portion of the cap layer extrudate moves into the upper flow channel 232 while another portion moves through the lower flow channel 234. The inlet 212, the upper flow channel 232, and the lower flow channel 234 are sized and shaped such that streakers remaining in the cap extrudate are not substantially further disturbed. Similarly, with the exception of the splitting of the inlet 212 into the upper flow channel 232 and the lower flow channel 234, the streaked HDPE from the static mixer 208 is largely undisturbed.

As the cap extruder 154 forces the cap extrudate into the co-extrusion chamber 230, the temperature of the cap layer extrudate is nominally maintained at about 340 degrees Fahrenheit. This is just below the melting point of the streaker pellets at the pressure within the co-extrusion chamber 230. As the cap layer extrudate moves into the co-extrusion chamber 230, some tumbling of the cap layer extrudate occurs.

Additionally, the cap layer extrudate encounters the core 104 which has moved into the co-extrusion chamber 230 as described above. This forces some of the cap layer extrudate to move laterally within the co-extrusion chamber 230. The height of the co-extrusion chamber 230 (H_{CC}) is greater than the height of the core extruder channel 180 at the outlet (H_{CO}) and the width of the co-extrusion chamber 230 (W_{CC}) is greater than the width of the core extruder channel 180 at the outlet (W_{CO}). Accordingly, lateral movement of the cap layer extrudate continues until the core 104 is completely surrounded.

The temperature and pressure of the core 104 and the cap layer extrudate within the capping die 214 is controlled by the controller 252 such that fusing of the cap layer extrudate with the core 104 occurs. In particular, the controller 252 controls movement of the core 104 into the co-extrusion chamber 230, and thus into the cap layer extruder channel 220, along with the flow of cap layer extrudate into the co-extrusion chamber 230, such that as the core 104 moves into the cap layer extruder channel 220, the core 104 is surrounded by the cap extrudate.

The height of the cap layer extruder channel 220 (H_{CL}) is larger than the height of the outlet (H_{CO}) but less than the height of the co-extrusion chamber 230 (H_{CC}). Additionally, the width of the cap layer extruder channel 220 (W_{CL}) is larger than the width of the outlet (W_{CO}) but less than the width of the co-extrusion chamber 230 (W_{CC}). Accordingly, as the core 104 and the cap layer extrudate enter the cap layer extruder channel 220, pressure is increased resulting in fusing of the cap layer extrudate with the core 104. Additionally, any remaining streakers in the cap layer extrudate are melted, and streakers near the outer edge of the cap layer extrudate encountering the edge of the cap layer extruder channel 220 are streaked thereby forming further streaked HDPE.

At block 286, the shaped core 104 with the coating of streaked cap layer is then passed to a calibrator and thereafter cut to length. The calibrator is submerged in a vacuum bulkhead of the calibration tank, and acts as a form to which the extrudate expands as the gas pressure created by the foaming normalizes after exiting the die. The calibrator is predrilled with small vacuum holes and the bulkhead is kept under negative pressure to assist the gas in forcing the extrudate to the inside of the form and to keep the extrudate from distorting as the extrudate cools. The entire calibrator can be submerged/spray cooled or cooled by closed loop cooling channels built into the tool. Additional racks in the following tanks hold plates with the profile shape machined thru them. The plates help to hold the shape of the part as it is further cooled. Both the calibrator and the plates are sized with the understanding that the part shrinks during cooling.

After cooling, the co-extruded boards in some embodiments exhibit a graining pattern similar to the board 100 depicted in FIG. 1. In particular, the co-extruded cap layer 106 of the board 100 includes streaks 124.

Once the desired graining has been obtained, additional processing of the board may be undertaken at block 288. In some embodiments, the controller 252 controls the embossing station 262 such that silicone wheels are heated and pressed into the surface of the profile to remove sheen, die lines and imperfections. The resulting surface texture presents as a dry matte finish. In some embodiments, the board travels through a heat tunnel which re-plasticizes the co-extruded outer surface or the exposed outer surface. Engraved wheels with a wood grain texture are pressed into the plasticized surface and transfer the texture into the co-extruded part.

At block 290 the co-extruded boards are cut to desired lengths.

The above-described process can be modified to provide different aesthetic results. By simply modifying the amount of streakers, it is possible to produce variations in the appearance of the grain. Additional complexity can be achieved by the use of additional colors in both the base resin and the streakers. Moreover, modification of the shape of the streakers will result in a variation of the shape of the resultant grains.

Other steps in the process can be further modified to provide variations in the graining. As noted above, the amount, color, and shape of streakers can be modified. Moreover, the feed rate of the streakers can be varied within a given extrusion to provide additional randomness.

The above-described disclosure thus provides an apparatus for manufacturing co-extruded HDPE boards having color variations throughout an HDPE cap layer which represent “grain” or growth rings found in natural timbers. The variations in color randomly present as cathedrals, arches, chevrons, feathering and movement. The co-extruded boards are formed using readily available base resins and additives.

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected.

1. An extruded board comprising:
an extruded core having an outer circumference, the outer circumference including a first side and a second side opposite to the first side, the core including foamed high density polyethylene (HDPE); and
a cap layer co-extruded on the first side, the cap layer including at least one co-extruded streak portion at an outer surface of the cap layer, the at least one co-extruded streak portion including HDPE which is colored differently from an adjacent co-extruded HDPE portion of the outer surface.

2. The extruded board of claim 1, wherein the outer surface is embossed.

3. The extruded board of claim 2 wherein:
the at least one co-extruded streak portion comprises a plurality of co-extruded streak portions; and
each of the plurality of co-extruded streak portions is non-determinatively distributed in the cap layer.

4. The extruded board of claim 3, wherein the cap layer extends completely around the outer circumference of the extruded core.

5. The extruded board of claim 4, wherein:
the extruded core is colored using a first color concentrate;
the cap layer is colored using a second color concentrate;
the first and second color concentrate have the same color; and
the plurality of co-extruded streak portions are colored using a streaker having a color different from the color of the first and second color concentrate.

6. The extruded board of claim 5, wherein each of the plurality of co-extruded streak portions exhibit uneven thickness, uneven width, or uneven length.

7. The extruded board of claim 6, wherein each of the plurality of co-extruded streak portions exhibit uneven thickness, uneven width, and uneven length.

8. The extruded board of claim 4, wherein the plurality of co-extruded streak portions comprises:
a first streak portion having a first color formed using a streaker having a first color; and
a second streak portion having a second color formed using a streaker having a second color, wherein the first and second colors are different colors.

9. A method of forming the extruded board of claim 1, comprising:
melting a first high density polyethylene (HDPE) resin;
foaming the melted first HDPE resin;
extruding the foamed first HDPE resin through a first die using a first extruder to form the extruded core;
melting a second (HDPE) resin;
providing a plurality of first color streakers in the melted second HDPE resin;
elongating the plurality of first color streakers in the melted second HDPE resin to form at least one streaked HDPE portion of melted second HDPE resin, the at least one streaked HDPE portion including HDPE which is colored differently from an adjacent portion of the melted second HDPE resin; and
forming the cap layer by co-extruding the at least one streaked HDPE portion and the adjacent portion of the melted second HDPE resin onto the first side of the extruded core using a second extruder, wherein the co-extruded at least one streaked HDPE portion forms the at least one co-extruded streak portion at the outer surface of the cap layer.

10. The method of claim 9, further comprising:
embossing the outer surface of the cap layer.

11. The method of claim 10, wherein:
the at least one co-extruded streak portion comprises a plurality of co-extruded streak portions; and
each of the plurality of co-extruded streak portions is non-determinatively distributed in the cap layer.

12. The method of claim 11, wherein forming the cap layer further comprises:
forming the cap layer completely around a circumference of the core.

13. The method of claim 12, wherein:
the foamed first HDPE resin is colored using a first color concentrate;
the melted second HDPE resin is colored using a second color concentrate;
the first color concentrate and the second color concentrate have the same color; and
the streakers have a color different from the color of the first color concentrate and the second color concentrate.

14. The method of claim 12, wherein:
the foamed first HDPE resin is colored using a first color concentrate;
the melted second HDPE resin is colored using a second color concentrate;
the first color concentrate and the second color concentrate have the same color;
the streakers include a first plurality of streakers having a first color;
the streakers include a second plurality of streakers having a second color;
the first color is different from the second color; and
the color of the first color concentrate and the second color concentrate is different from the first color and the second color.

15. The method of claim 9, wherein forming the cap layer comprises:
providing a co-extruder die, the co-extruder die including
a cap layer extruder channel aligned with the first die and configured to receive the core, the cap layer extruder channel having a height and a width greater than a height and a width of the core,
an inlet operably connected to the second extruder,
a first flow channel extending from the inlet to a location above the cap layer extruder channel and opening to an upper co-extrusion chamber, and
a second flow channel extending from the inlet to a location below the cap layer extruder channel and opening to a lower co-extrusion chamber,
wherein:
the upper co-extrusion chamber and the lower co-extrusion chamber form a co-extrusion chamber positioned between the first die and the cap layer extruder channel, the co-extrusion chamber configured to receive the core from the first die,
the co-extrusion chamber has a height and a width greater than the height and the width of the cap layer extruder channel; and
contacting the core with the at least one streaked HDPE portion and the adjacent portion of the melted second HDPE resin completely around a circumference of the core in the co-extrusion chamber.
